(19) United States
(12) Patent Application Publication
(10) Pub. No.: US 2016/0334891 A1
(43) Pub. Date: Nov. 17, 2016

(54) DIGITAL STYLUS WITH COLOR CAPTURE AND REPLICATION

(71) Applicant: Scribble LLC, Las Vegas, NV (US)

(72) Inventors: Raluchukwu Ozoemenam, Dallas, TX (US); Yangzhong Wang, Jiang Su (CN)

(21) Appl. No.: 14/714,176

(22) Filed: May 15, 2015

(51) Int. Cl. G06F 3/0354; G09G 3/36; G06T 7/40; G06F 3/042; G06F 3/041

(52) U.S. Cl. CPC G06F 3/03545; G06F 3/0425; G06F 3/0412; G06T 7/408; G09G 3/36

(57) ABSTRACT

A digital stylus with color capture and replication, comprising a stylus body adapted to provide a comfortable grip for a user and to enclose a color capture module, a stylus tip adapted to be affixed or inserted into a stylus body and to interact with a touchscreen electronic device, and a color capture module adapted to operate within a stylus body and comprising a plurality of optical sensors adapted to accurately capture a color value from an object or image placed in view of the sensor, and a method for operation of a digital stylus with color capture and replication.

### CROSS-REFERENCE TO RELATED APPLICATIONS

None.

### BACKGROUND OF THE INVENTION

1. Field of the Art

The disclosure relates to the field of digital media, and more particularly to the field of color replication in digital photography and graphic design.

2. Discussion of the State of the Art

In the art of digital media, users often wish to digitally recreate images and colors found in the physical world. Generally, they need to manually adjust color settings in an imaging program such as Adobe PHOTOSHOP™, to try and achieve the desired result. A much easier method would be to scan or “capture” a color value from an object, image, or other physical source, such as to physical scan colors from objects or scenes found in nature (such as scanning plants to paint flowers digitally).

In the art, there are some devices that allow the scanning of natural colors for use in electronic media creation. These devices generally allow a user to sample a color from an object such as a leaf, and the color sample is sent to their imaging software for use. Some devices in the art also allow for the storage of color values to build a palette or maintain a history of scanned colors, for further ease of use. However, no solution in the art assists a user in seeing what color they are sampling in the moment, instead requiring them to review the color in their imaging software. This creates a complication when a user wishes to scan colors without having their computer or software available, for example on a nature walk or at a restaurant for a meal. Additionally, these devices all require the use of a computing device and imaging software to function, in a “tethered” approach wherein the device and computer are in communication while the user scans a color.

What is needed, therefore, is a device that enables a user to view colors prior to sampling, so they may select a desired color without needing to resample an object repeatedly until they achieve a desired color value. What is further needed is a device that can operate in an “untethered” fashion, operating in a standalone fashion to view and scan colors, storing color values for later use when a computer or imaging software is available.

### SUMMARY OF THE INVENTION

Accordingly, the inventor has conceived and reduced to practice, in a preferred embodiment of the invention, a digital stylus with color capture and replication, and a method for operating a digital stylus with color capture and replication.

According to a preferred embodiment of the invention, a digital stylus with color capture and replication, comprising a stylus body comprising at least a pen-shaped rigid housing, the housing comprising at least a cylindrical rigid portion adapted to provide a comfortable grip for a user and a hollow portion adapted to at least partially enclose a color capture module; a stylus tip comprising at least a conic portion adapted to be affixed or inserted into a stylus body and further adapted to interact with at least a touchscreen electronic device; and a color capture module comprising at least a computing device adapted to operate within at least a portion of a stylus body and further comprising a plurality of optical sensors adapted to accurately capture a color value from an object or image placed in view of the sensor, the color value comprising at least a hue value, is disclosed.

According to another preferred embodiment of the invention, a method for operating a digital stylus with color capture and replication, comprising the steps of: capturing, via a color capture module, a color value from a physical object or displayed image; storing the captured color value for future reference; illuminating a plurality of elements based at least in part on the captured color value; and sending the color value to a computing device, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating an exemplary arrangement of a digital stylus with color capture and replication, according to a preferred embodiment of the invention.

FIG. 6 is a block diagram illustrating an exemplary system architecture for utilizing a digital stylus with color capture and replication, according to an embodiment of the invention.

FIG. 7 is a method flow diagram illustrating an exemplary method for operating a digital stylus with color capture and replication, according to a preferred embodiment of the invention.

FIG. 8 is a block diagram illustrating an exemplary system architecture for a digital stylus with color capture and replication, according to a preferred embodiment of the invention.

### DETAILED DESCRIPTION

The inventor has conceived, and reduced to practice, in a preferred embodiment of the invention, a digital stylus with color capture and replication, and a method for operating a digital stylus with color capture and replication.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions.

Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions.

Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

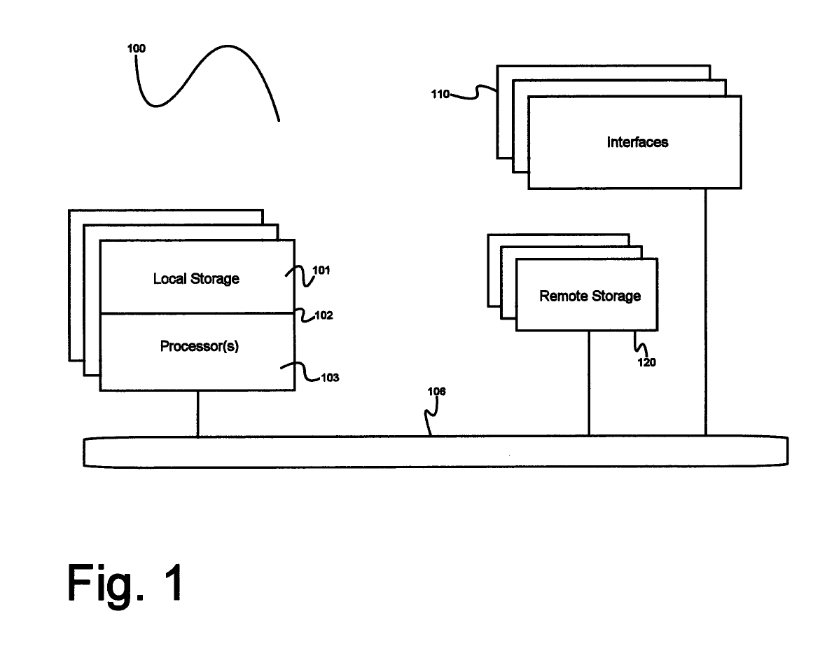

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs).

Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD- ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

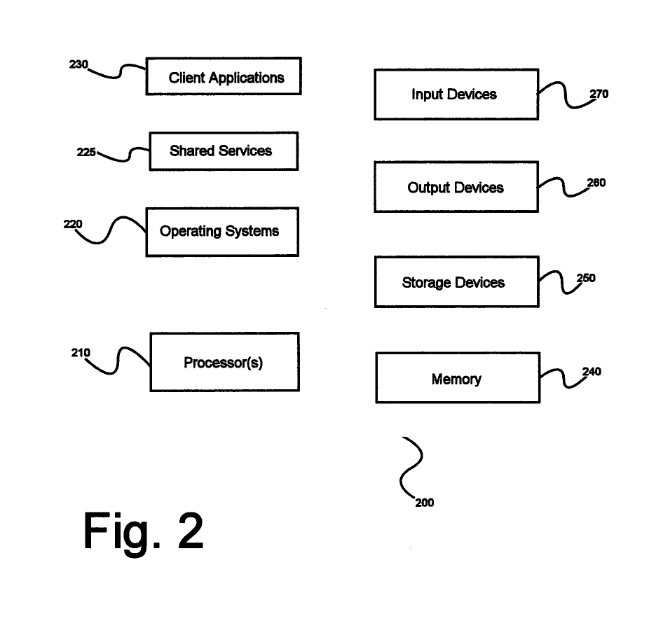

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

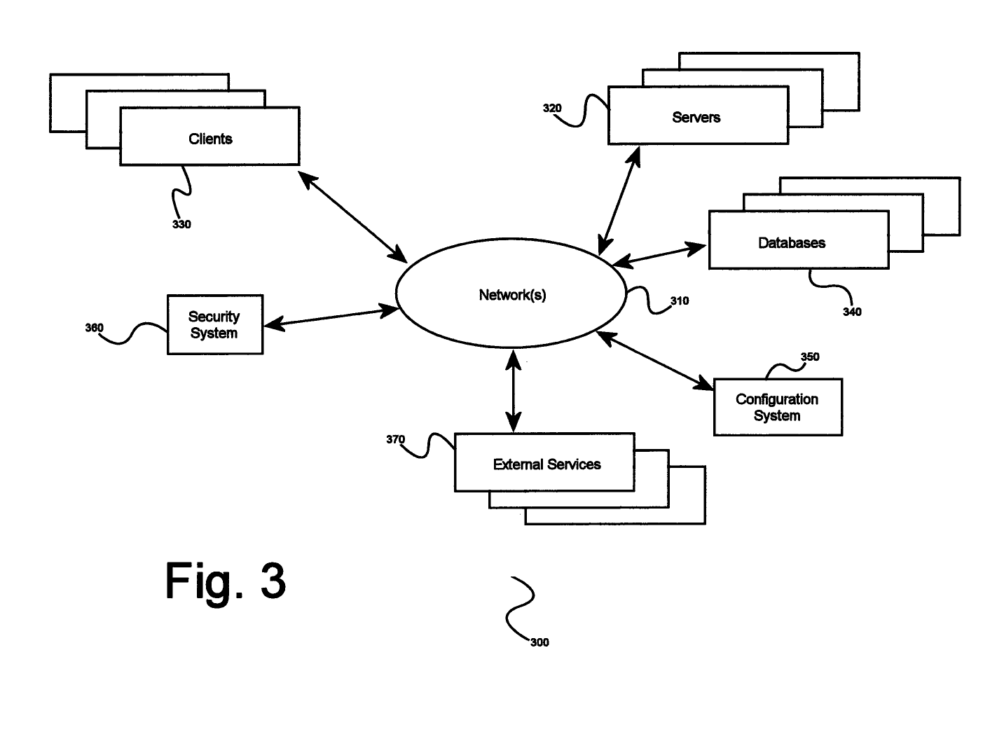

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

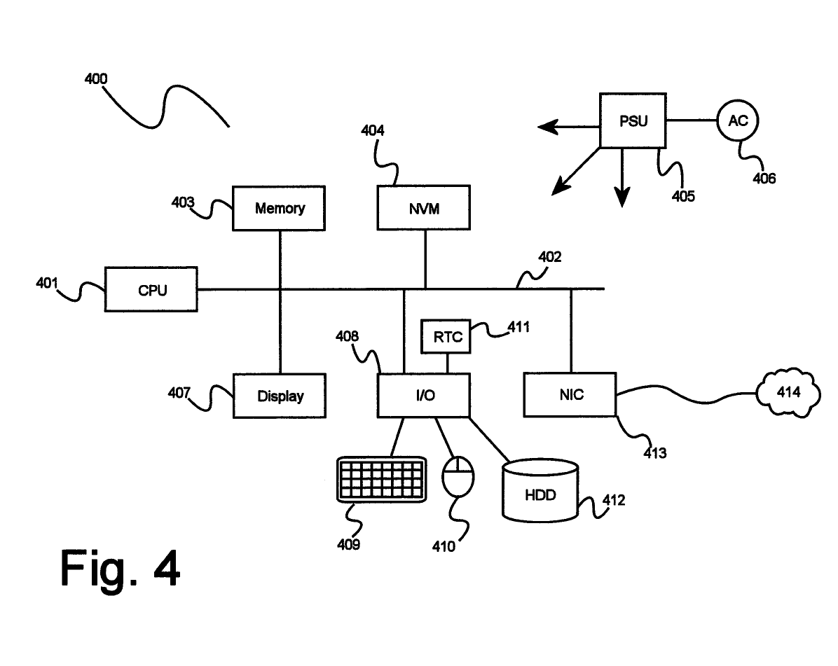

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

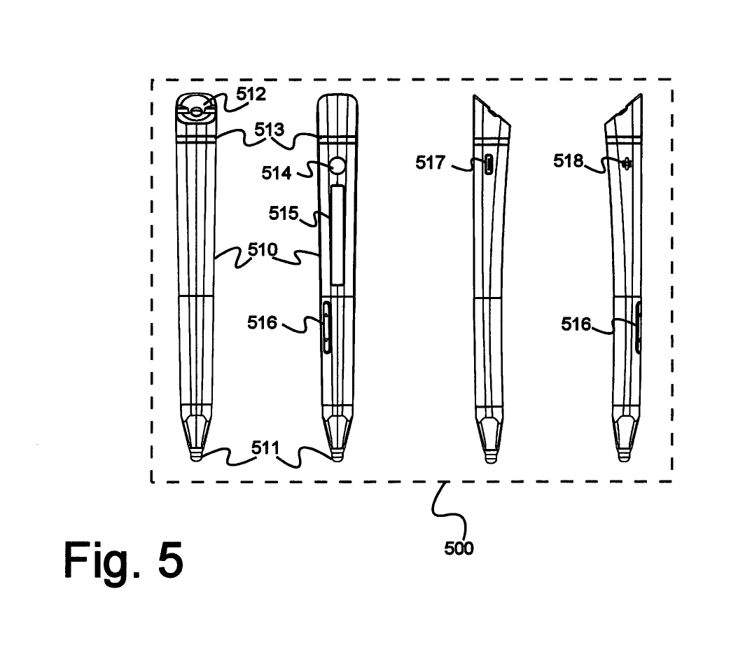

FIG. 5 is a block diagram illustrating an exemplary arrangement of a digital stylus 500 with color capture and replication, according to a preferred embodiment of the invention. According to the embodiment, a stylus 500 may comprise a rigid body 510, generally of a cylindrical or pen-like shape suitable for grasping. It should be appreciated that while a particular physical shape is illustrated and reference may be made to particular components or arrangements, a wide variety of physical shapes and arrangements may be utilized according to the invention, such as different locations or arrangements of interactive features (like buttons or LED lights), or differently-shaped stylus bodies for different purposes (such as to resemble a paintbrush, airbrush, pencil, or other visual design tools or implements), or for ergonomic purposes.

Stylus 500 may further comprise a stylus tip or “nib” 511, which may be of a generally conic or rounded shape suitable for tapping, writing, or other interaction with a touchscreen electronic device such as a tablet input device (for example, Wacom INTUOS™) or a tablet computer (for example, Apple IPAD™ or Wacom CINTIQ™). It should be appreciated that the specific shape and material composition of a nib 511 may vary according to a particular arrangement, such as utilizing specific materials for interaction with particular touchscreen technologies (for example, capacitive-based touchscreens or radio-frequency digitizers), or for specific uses (such as a fine tip for sketching or a broad tip for painting). Nib 511 may be modular or removable in design, such that a user may replace with different shapes or types of nibs for specific purposes as described above, or to replace a worn-out or damaged nib.

Stylus 500 may further comprise a color capture module 512 comprising an image sensor (such as a camera) and electronic components that may operate inside stylus body 510 and be adapted to perform image processing or storage functions (not shown). Color capture module 512 may be placed over an object (or an object brought into view), and may then process the resulting captured image and determine a color value based on the appearance of the object in view. For example, holding a stylus 500 over a leaf may result in a color capture module 512 identifying and capturing a specific shade of green, based on the appearance of the portion of the leaf that is in direct view. Stylus 500 may further comprise a plurality of interactive components such as illuminating portions or color band 513 (for example, an array of LEDs or an LCD or other display type) that may visually indicate a captured color value, a plurality of buttons for capturing a color 515 or clearing a color value 514 (that is, removing the value from operating memory, and returning to a default “empty” state as if no color value had been captured), or for viewing or selecting previously-stored color values 516 (such as to scroll through a color palette and select a particular value for use). In this manner, a user may interact directly with a stylus 500 to capture, view, select, store, retrieve, or delete color values, all without the use of an external computing device or software application. It may be appreciated that such functionality may be greatly useful, enabling users to setup complex color palettes without the aid of a computer, for example to store a variety of colors while traveling, hiking, shopping, or any other such activity where it may be impractical or impossible to have a computer available.

Additionally, a color capture module 512 may continually update a color value indicated by illuminated elements 513, for example to view specific color values in real-time while moving the color capture module 512 over an object. For example, a user may slowly move a stylus 500 over the surface of an object with complex coloration (such as a flower or animal fur, for example), to view possible color values. When the user finds a value they wish to store (as indicated by the color of color band or illuminating portions 513), they may press a capture button 515 and that value will be committed to memory. This functionality may be considered as a “live preview” of color values, so that a user may select the most desirable color value without having to repeatedly scan, review, delete, and re-scan color values.

According to the embodiment, a stylus body 510 may further comprise an external charging port 517 to enable charging of an integral or removable internal battery (not shown), enabling “untethered” use—that is, use without any cables or wires connecting to an external power source or computing device. It may be appreciated that such functionality may greatly enhance convenience and usefulness for a user, as they may charge a stylus 500 before leaving their home or office, and use it to scan color values without having to bring any additional hardware. Stylus body 510 may also comprise an attachment 518 for a lanyard or tether, so that a user may choose to secure a stylus 500 around their wrist or clothing, to prevent loss or theft.

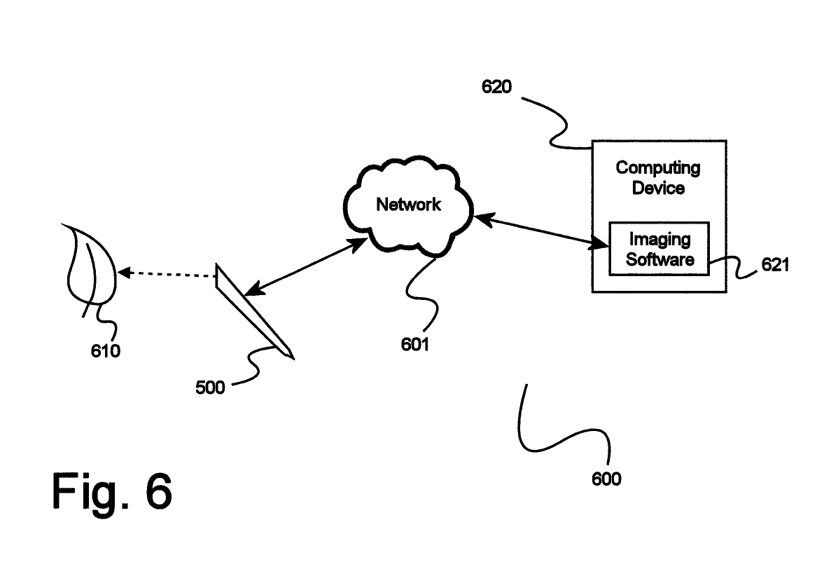

FIG. 6 is a block diagram illustrating an exemplary system architecture 600 for utilizing a digital stylus 500 with color capture and replication, according to an embodiment of the invention. According to the embodiment, a stylus 500 may communicate via a network 601 such as the Internet, for example via a WiFi or BLUETOOTH™ radio connection (or any other suitable wired or wireless data communication connection). Stylus 500 may then interact with imaging software 621 operating on a computing device 620 (such as a personal computer or tablet computing device), for example Adobe PHOTOSHOP™ or other such digital imaging software applications. Stylus 500 may then capture a color value from an object 610 (for example, a leaf), optionally storing the captured value in local memory (that is, memory operating on the stylus 500), and may send the captured color value to imaging software 621 for use. As mentioned above, a user may capture of plurality of colors offline (that is, not in communication with computing device 620), and then select from among the plurality of captured colors and send the selected color to computing device 620. For example, a user may capture a color value from a leaf 610, which may then be stored in their stylus 500 for future use (such as to build a color palette or view a history of captured values), and the color captured from the leaf may be sent to computing device 620 where it may be stored as a color swatch in imaging software 621. They may then use stylus 500 to draw or paint with a captured color value by interacting with computing device 620, such as by using stylus 500 to interact with a touchscreen interface or by interacting via other computer input devices (such as a mouse or keyboard). In this manner it can be appreciated that a stylus 500 may be used solely as a color capture device, for example with computers that may not have a touchscreen input capability (such as a desktop). By storing captured color values in a local memory operating on a stylus 500, a user may use the same color value on multiple computing devices—for example, they may scan a leaf for use in their imaging software as described above, then travel to a different location where they have another computing device (such as a home office). Stylus 500 may then provide the stored color value to the new computing device, enabling a “scan once” method of use whereby a user need not re-scan an object to continue using a color value.

A variety of additional or alternate functionality may be enabled through software operating on a computing device 620 in communication with a stylus 500, for example to configure the nature of captured color values. For example, a user might select a “full bright” configuration option and disable the capturing of luminance values; a captured value might then comprise only hue and saturation, and luminance would be set to a maximum or specific value, rather than the actual detected value (as may be useful for capturing color values in dim lighting, such as indoors). Another example may be configurable color “deterioration” settings, to simulate a more natural painting experience. For example, a user may configure deterioration for a captured color value, such that as they use the color value in an imaging program, it fades or otherwise is depleted over use, requiring them to then re-scan the source of the color value, simulating the need to periodically dip a pen in ink or brush in paint. Such configuration options may enable a user to fine-tune the specific behavior of their stylus to match their preferred art style or a specific use, and furthermore such configurations may be optionally stored on a computing device (so a user may configure specific settings on a per-computer basis), or in an internal memory operating on a stylus 500 so a user may configure “per-brush” settings for a stylus, optionally setting up multiple styli with different configurations for different uses, rather than having to reconfigure a single stylus repeatedly as their uses change.

### DETAILED DESCRIPTION OF EXEMPLARY EMBODIMENTS

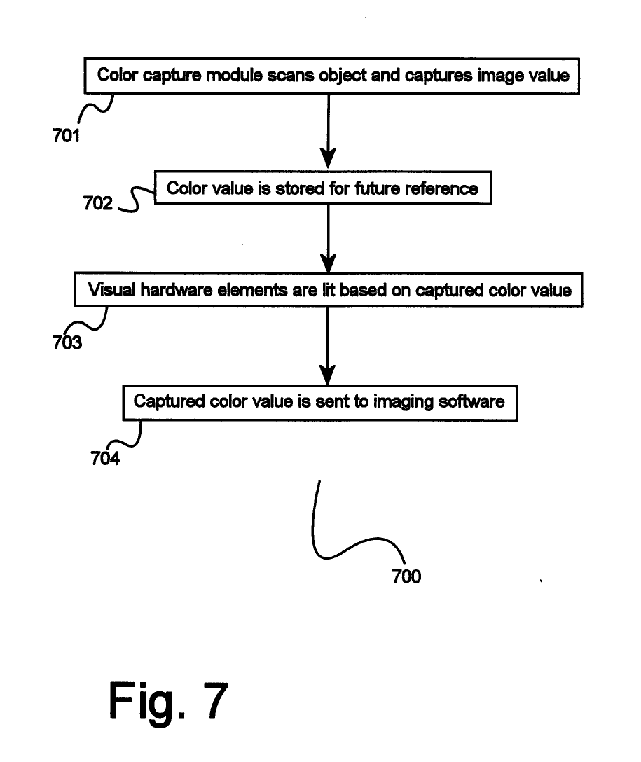

FIG. 7 is a method flow diagram illustrating an exemplary method 700 for operating a digital stylus with color capture and replication, according to a preferred embodiment of the invention. In an initial step 701, a color capture module may capture a color value from a physical object or displayed image placed in front of an image sensor such as a camera. For example, a leaf placed in front of an image sensor may be scanned, and a specific shade of green may be captured, corresponding to a particular shade of green on the surface of the leaf directly in front of the sensor. Various color attributes may be programmed or configured for capture, such as hue, luminosity or brightness, saturation, opacity, or any other visual attribute that may be assigned to a specific color in digital graphic design. For example, a pane of stained glass may be scanned to capture a particular color with transparency information, or a user may adjust lighting in an area to capture variances in color caused by the lighting (such as muted colors in dim lighting, or color shift when using different lighting temperatures). In some embodiments, additional controls such as buttons or sliders may be provided on stylus 500 to allow manual setting of such additional color attributes; for example, such optional color attributes might be varied for each color capture operation as desired. In a next step 702, a captured color value may be stored for future reference, such as to maintain a history of captured colors or to build a color palette for later use in digital painting or photo reproduction. In a next step 703, a plurality of elements such as light-emitting diodes (LEDs), liquid crystal displays (LCDs), laser emitters, or any other device or component that may emit or reflect specific frequencies of light (that is, specific color values) may be illuminated based at least in part on a captured color value. For example, upon scanning a leaf, an LED or an array of LEDs may light up in the shade of green that was captured, so a user has immediate visual feedback on the results. In a preferred embodiment, a color band 513 is provided that is placed around a circumference of stylus 500 to allow easy viewing without regard to orientation of stylus 500 relative to a user's field of view. This may be useful in determining whether the desired color was captured, for example in a mottled or variegated surface; additionally, color band 513 would be useful in selecting from among stored captured colors, or for visual feedback while using stylus 500 as a writing implement in conjunction with computing device 620. Additionally, colors reproduced via the illuminated elements may be updated in real-time based on input from an image sensor, such that a user may move the stylus across an object or image and see the colors being detected, stopping when they see one they like and then choosing to capture it (such as by pressing a capture button or holding the stylus over the same color for a specified length of time, for example). In a final step 704, a captured color value may be sent to a computing device such as a smartphone, tablet computer, or desktop workstation. For example, a digital artist may scan a color from a physical object they are reproducing in an image, and the captured color value may then be sent to a digital painting software application (such as Adobe PHOTOSHOP™, for example) operating on their computer, where they may then use the color value in their work. In this manner, colors may be scanned and optionally stored on the stylus or sent to a computing device for immediate use, or combinations of both operations such as to build a color palette by scanning objects found in nature, then viewing stored values and sending some or all of them to a computing device at a later time (such as upon returning home or to an office).

According to another embodiment, a stylus may receive input from a computing device, for example instructions to retrieve a stored color value. The stylus may then read a stored color value from memory, for use as a captured color value without actually having to re-scan an object. Appropriate visual hardware elements may be illuminated based on the retrieved color value, and a user may then continue using the stylus for digital interaction (such as painting with the retrieved color value), or may scan a new color value. Various behavior arrangements may be programmed or configured, for example through a software application on a computing device that may communicate with the stylus via a network. For example, a user may configure a stylus such that if they scan a new color value, it may override a stored color value and replace it in a stored palette or history, allowing the user to “update” their palette such as if they decide they prefer a different shade from one originally captured.

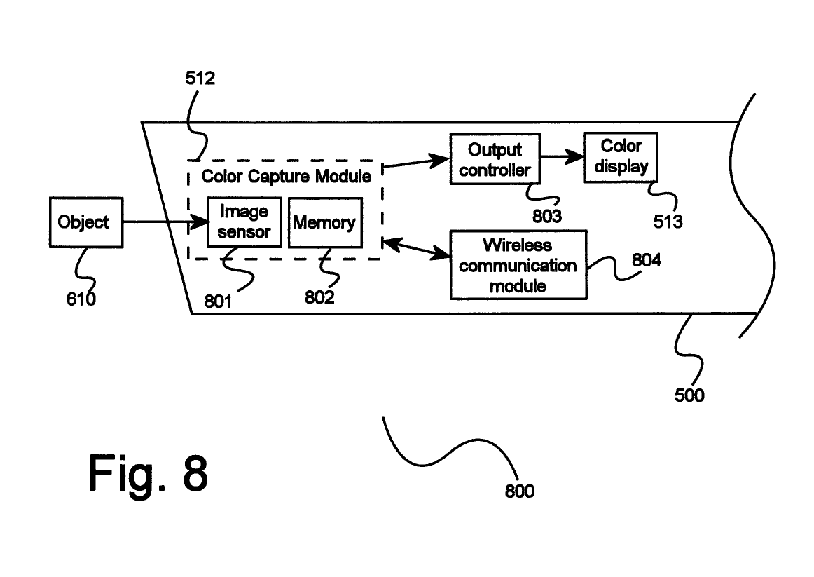

FIG. 8 is a block diagram illustrating an exemplary system architecture 800 for a digital stylus 500 with color capture and replication, according to a preferred embodiment of the invention. According to the embodiment, stylus 500 may comprise a plurality of electronic components adapted to provide color capture and replication functions, such as fixed or removable components enclosed internally or integrally-formed as part of stylus 500. For example, stylus 500 may enclose a plurality of electronic components internally, such as in a waterproof compartment integrally formed within stylus 500, for example for use in underwater color capture or for use in inclement weather or other conditions that may be unsuitable for exposed electronics.

According to the embodiment, a color capture module 512 may be used for sampling a color from an object 610 such as a physical object with a colored surface or portion, or an image displayed on a physical medium such as a paper or display screen. Color capture module 512 may comprise an image sensor 801 that may be any suitable image sensing device such as a charge-coupled device (CCD) or complementary metal-oxide-semiconductor (CMOS) camera sensor, photoresistor, or any other suitable device for detecting and conveying image information electronically. For example, specific image sensor types may be used in a stylus 500 adapted for a special purpose, such as to detect ambient light color and intensity, or to detect non-visible light spectra such as ultraviolet or infrared. A particular use may be an artist using a stylus 500 to detect ambient ultraviolet light spectra, and translating captured ultraviolet “color” into visible color for use in digital art (for example, to create an image showing what an object may look like outside of the normal human visual spectrum).

An image sensor 801 may detect a color (in a process referred to as “sampling”) from an object 610, and may store a sampled color in a memory 802 in a process referred to as “capturing”. This “captured” color may then be stored for future reference, and a captured color or a current output from an image sensor 801 may be presented to an output controller 803 for use in determining the operation of a color display 513. Color display 513 may be any suitable illuminable element such as an LED or LED array, laser diode, LCD, or any other suitable device that may be used to visually display or emit light according to a captured color. In this manner, a user may visually determine a captured color by looking at a color display 513, or when displaying a current output from an image sensor 801 they may view a color prior to capture (such as to precisely view a plurality of colors on the surface of an object 610 prior to selecting a desired one to capture).

Additionally, a wireless communication module 804 may be utilized to communicate with external devices via a network, such as to send captured colors stored in a memory 802 to a computing device wirelessly. Wireless communication module 804 may employ any appropriate communications technology or protocol, such as WiFi, BLUETOOTH™, near-field communication (NFC), or any other suitable means of conveying electronic information wirelessly between devices. As illustrated, communication may operate in a two-way fashion, for example to enable a stylus 500 to send a captured color to a computing device while also receiving input from a computing device, such as instructions for operation. For example, according to a particular configuration a stylus 500 may be instructed to modify a captured color stored in a memory 802 over time or during use (such as while drawing or painting with the captured color in an imaging software operating on a computing device), such as to simulate the draining of ink from a pen, or the consumption of paint on a brush during use. As a captured color is modified, an output controller 803 may update the presented color via a color display 513, so a user may visually confirm the state of their captured color, for example to know when to refresh the color such as by re-capturing from a source object 610, simulating the need to dip their pen or brush to continue their work. Such color modification or depletion may also operate in a timed fashion, for example via a timer operating as a part of wireless communication module 804, or via received communication from an external timing source such as a clock operating on a computing device. For example, if a user does not use a captured color immediately, it may be modified to simulate the fading of ink or the drying of paint, based on a measured time since the color was captured.

The skilled person will be aware of a range of possible modifications of the various embodiments described above. Accordingly, the present invention is defined by the claims and their equivalents.

What is claimed is:

1. A digital stylus with color capture and replication, comprising:
a stylus body comprising at least a pen-shaped rigid housing, the housing comprising at least a generally cylindrical rigid portion adapted to provide a comfortable grip for a user and a hollow portion adapted to at least partially enclose a color capture module;
a stylus tip comprising at least a conic or hemispherical portion adapted to be affixed or inserted into a stylus body and further adapted to interact with at least a touchscreen electronic device; and
a color capture module comprising at least a computing device adapted to operate within at least a portion of a stylus body and further comprising a plurality of optical sensors adapted to accurately capture a color value from an object or image placed in view of the sensor, the color value comprising at least a hue value.

2. The system of claim 1, wherein the color value further comprises at least a saturation value.

3. The system of claim 1, wherein the color value further comprises at least a brightness value.

4. The system of claim 1, wherein the color value further comprises at least an opacity value.

5. The device of claim 1, further comprising a memory operated by the color capture module, wherein the optical sensor stores a captured color value in the memory.

6. The device of claim 1, further comprising at least a plurality of illuminated elements, wherein the illuminated elements illuminate at a specific color based at least in part on a color value captured by a color capture module.

7. The system of claim 6, wherein the illuminated elements comprise at least a plurality of light-emitting diodes.

8. The system of claim 6, wherein the illuminated elements comprise at least a plurality of lasers.

9. The system of claim 6, wherein the illuminated elements comprise at least a plurality of liquid crystal displays.

10. The system of claim 1, wherein the color capture module provides at least a color value to a computing device.

11. A method for operating a digital stylus with color capture and replication, comprising the steps of:
capturing, via a color capture module mounted in a stylus body comprising at least a pen-shaped rigid housing, the housing comprising at least a generally cylindrical rigid portion adapted to provide a comfortable grip for a user, a color value from a physical object or displayed image;
storing the captured color value for future reference within a memory within the stylus body;
illuminating a plurality of elements on one or more surfaces of the stylus body based at least in part on the captured color value; and
sending the color value to a computing device.

12. The method of claim 11, further comprising the steps of:
receiving input from a computing device;
retrieving a stored color value based at least in part on the received input; and
illuminating a plurality of elements based at least in part on the retrieved color value.
